(19) United States
(12) Patent Application Publication
(10) Pub. No.: US 2014/0240281 A1
(43) Pub. Date: Aug. 28, 2014

(54) TOUCH PANEL INPUT DEVICE AND TOUCH PANEL INPUT DETECTION METHOD THEREOF

(71) Applicant: HiDeep Inc., Gyeonggi-do (KR)

(72) Inventor: Jeong Hwan Lee, Gyeonggi-do (KR)

(73) Assignee: HiDeep Inc., Gyeonggi-do (KR)

(21) Appl. No.: 14/186,602

(22) Filed: Feb. 21, 2014

(30) Foreign Application Priority Data
Feb. 22, 2013 (KR) 10-2013-0019380

(51) Int. Cl. G06F 3/044; G06F 3/041

(52) U.S. Cl. CPC G06F 3/044; G06F 3/0418
USPC 345/174

(57) ABSTRACT

Disclosed are a touch panel input device and a touch input detection method in accordance with the present invention, which include a plurality of intervals in which a driving signal is simultaneously driven to at least two of a plurality of driving signal lines and the driving signal is not driven to the at least one driving signal line. A combination of the driving signal line to which the driving signal is driven in one of the plurality of the intervals and the driving signal line to which the driving signal is not driven in the one interval may be different from a combination of the driving signal line to which the driving signal is driven in an interval different from the one interval and the driving signal line to which the driving signal is not driven in the different interval.

### BACKGROUND

1. Field

The present invention relates to a touch panel input device and a touch panel input detection method thereof, and more particularly to a touch panel input device capable of improving a signal-to-noise ratio of a touch panel and a touch panel input detection method thereof.

2. Description of Related Art

In general, with the development of electronic communication technologies, a variety of electronic devices are being provided. Such an electronic device increasingly has a tendency to emphasize manipulation easiness for users and a good design. It is diversification of an input device represented by a keyboard or a keypad that is emphasized according to the trend.

The input device has been developed from data processing through the input device, e.g., a keyboard, a keypad, etc., to an available touch panel functioning as both an input device and an output device. The touch panel commonly designates an input device allowing a user to input by touching a display screen without separate input equipment.

A common touch panel detects whether a touch is input or not by detecting a capacitance stored in a plurality of node capacitors formed by row lines and column lines which are arranged to cross each other in the form of a matrix. The amount of the capacitance of the node capacitor changes according to a width of the row line, a width of the column line, an interval between the row lines and an interval between the column lines, and the like. The width of the row line, the width of the column line, the interval between the row lines and the interval between the column lines are not constant due to the process variation generated during the manufacture of the touch panel. Therefore, the amount of the capacitance of each node capacitor may not be constant. If the amounts of the capacitance of respective node capacitors are mutually different, the change amount of a voltage which is changed by the touch input and is charged in the node capacitor may be different depending on the node capacitor. If the change amount of the charged voltage is different depending on the node capacitor, the touch input may be misrecognized and the touch panel may malfunction.

### SUMMARY

One aspect of the present invention is a touch panel input device that includes: a touch panel including a plurality of driving signal lines and a plurality of sensing signal lines which form a plurality of node capacitors by crossing the plurality of the driving signal lines; a driving signal supplier which applies driving signals to the plurality of the driving signal lines; and a sensing signal unit which senses capacitances of the plurality of the node capacitors through the plurality of the sensing signal lines, wherein the driving signal supplier includes a plurality of intervals in each of which the driving signal is simultaneously driven to at least two of the plurality of the driving signal lines among the plurality of the driving signal lines and the driving signal is not driven to at least one driving signal line among the plurality of the driving signal lines, and wherein a combination of the driving signal line to which the driving signal is driven in one of the plurality of the intervals and the driving signal line to which the driving signal is not driven in the one interval is different from a combination of the driving signal line to which the driving signal is driven in an interval different from the one interval and the driving signal line to which the driving signal is not driven in the different interval.

Additionally, the driving signals in a certain time interval are represented by a matrix which is formed by a combination of time intervals during which the driving signals are driven and time intervals during which the driving signals are not driven according to a pseudo-random bit stream (PRBS) code.

Additionally, the sensing signal unit further includes an integrator. The integrator sums up the capacitances of the plurality of the node capacitors to which the driven driving signal is transmitted.

Additionally, the integrator sums up the capacitances of the node capacitors and outputs the summed result, and then resets the result.

Additionally, the sensing signal unit further includes an analog-digital converter which is connected to the integrator and converts the signal transmitted from the integrator into a digital signal.

Additionally, the touch panel input device further includes a controller. The controller controls the driving signal supplier and the sensing signal unit.

Another aspect of the present invention is a touch input detection method for sensing a location of the touch by detecting a capacitance of a node capacitor in a touch panel in which the node capacitor has been formed by crossing a driving signal line and a sensing signal line. The method includes: allowing driving signals to be applied to a plurality of the driving signal lines such that the driving signal is driven simultaneously to at least two of the plurality of the driving signal lines among the plurality of the driving signal lines in a first interval, and the driving signal is not driven to at least one driving signal line among the plurality of the driving signal lines; allowing the driving signal not to be driven in the second interval to at least one of the driving signal lines to which the driving signal has been simultaneously driven in the first interval among the plurality of the driving signal lines, and allowing the driving signal to be driven to at least one of the driving signal lines to which the driving signal has not been driven in the first interval; and calculating the capacitance of each of the node capacitors by comparing the summed capacitances of the node capacitors in the first interval with the summed capacitances of the node capacitors in the second interval.

Additionally, in the plurality of the driving signal lines, a driving cycle of the driving signal line to which the driving signal is driven and a driving cycle of the driving signal line to which the driving signal is not driven are in correspondence with a matrix formed by a pseudo-random bit stream (PRBS) code.

### BRIEF DESCRIPTION OF THE DRAWINGS

FIG. 1 is a view showing a structure of an embodiment of a touch panel input device according to the present invention;

FIG. 2 is a circuit diagram showing a connection relationship between a driving signal supplier, a sensing signal unit and a sensing capacitor shown in FIG. 1;

FIG. 3 is a timing diagram showing a first embodiment of a driving signal which is output from the driving signal supplier shown in FIGS. 1 and 2;

FIG. 4a is a view showing a matrix corresponding to a second embodiment of a waveform of the driving signal which is output from the driving signal supplier shown in FIGS. 1 and 2; and

FIG. 4b is a view showing an inverse matrix of the matrix shown in FIG. 4a.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, a touch panel input device and a touch panel input detection method thereof according to an embodiment of the present invention will be described with reference to accompanying drawings.

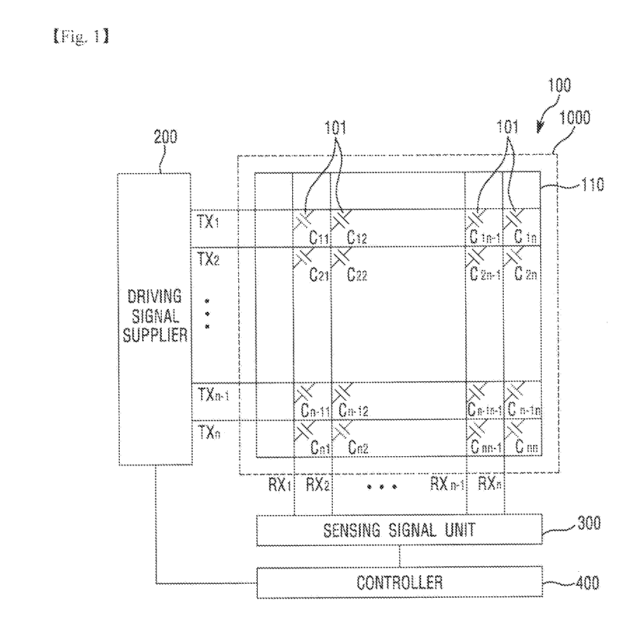

FIG. 1 is a view showing a structure of an embodiment of a touch panel input device according to the present invention.

Referring to FIG. 1, a touch panel input device 100 may include a touch panel 110 including a plurality of driving signal lines TX1, TX2, . . . , TXn−1, TXn and a plurality of sensing signal lines RX1, RX2 . . . , RXn−1, RXn which form a plurality of node capacitors 101 by crossing the plurality of the driving signal lines TX1, TX2, . . . , TXn−1, TXn, a driving signal supplier 200 which applies driving signals to the plurality of the driving signal lines TX1, TX2, . . . , TXn−1, TXn, and a signal unit 300 which senses capacitances of the plurality of the node capacitors 101 through the plurality of the sensing signal lines RX1, RX2, . . . , RXn−1, RXn.

The touch panel 110 may include the plurality of the driving signal lines TX1, TX2, . . . , TXn−1, TXn and the plurality of the sensing signal lines RX1, RX2, . . . , RXn−1, RXn, and may be arranged in a display unit 1000. A liquid crystal display (LCD), an organic light emitting display (OLED) and the like may be taken as an example of the display unit 1000 in which the touch panel 110 is formed.

The following descriptions and accompanying drawings take an example of the touch panel in which the plurality of the driving signal lines TX1, TX2, . . . , TXn−1, TXn and the plurality of the sensing signal lines RX1, RX2, . . . , RXn−1, RXn form an orthogonal array. However, the present invention is not limited to this. The present invention can be applied to another touch panel 110 having an array of arbitrary dimension, for example, a diagonal array, a concentric array, a 3-dimensional random array, etc., and an array obtained by the application of them. The plurality of the driving signal lines TX1, TX2 . . . , TXn−1, TXn and the plurality of the sensing signal lines RX1, RX2, . . . , RXn−1, RXn may be formed of a transparent conductive material (for example, indium tin oxide (ITO) or antimony tin oxide (ATO)) and the like. However, there is no limit to this. The plurality of the driving signal lines TX1, TX2, . . . TXn−1, TXn and the plurality of the sensing signal lines RX1, RX2, . . . , RXn−1, RXn may be formed of another transparent material or an opaque conductive material like copper, etc. Also, although it is shown that the number of the plurality of the driving signal lines TX1, TX2 . . . , TXn−1, TXn is the same as the number of the plurality of the sensing signal lines RX1, RX2, . . . , RXn−1, RXn, there is no limit to this.

In the touch panel 110, the plurality of the node capacitors 101 are formed in each area formed by the crossing of the plurality of the driving signal lines TX1, TX2, . . . , TXn−1, TXn and the plurality of the sensing signal lines RX1, RX2, . . . RXn−1, RXn. Here, although the plurality of the driving signal lines TX1, TX2, . . . , TXn−1, TXn and the plurality of the sensing signal lines RX1, RX2, . . . RXn−1, RXn are represented respectively by lines, they can be actually implemented with an electrode pattern. Also, the width of the driving signal lines TX1, TX2, . . . TXn−1, TXn may be different from the width of the plurality of the sensing signal lines RX1, RX2, . . . , RXn−1 RXn.

The driving signal supplier 200 gives the driving signals to the plurality of the driving signal lines TX1, TX2, . . . , TXn−1, TXn formed in the touch panel 110, and then supplies the driving signal to one end of the node capacitor 101. Here, the driving signal lines to which the driving signals are driven are differently selected according to each interval. The supplying of the driving signal may mean that a pulse is generated and transmitted to the driving signal lines. The pulse may be in a high-state or low-state. Regarding the driving signals generated by the driving signal supplier 200, it is intended that, in one interval, the driving signal is simultaneously driven to at least two of the plurality of the driving signal lines TX1, TX2, . . . , TXn−1, TXn, and the driving signal is not driven to the at least one driving signal line. Here, the “simultaneously” does not mean only the fact that the driving signal is driven to the at least two driving signal lines at the complete same time. The driving signals may be driven with a certain time difference.

The sensing signal unit 300 senses the amount of the capacitance of the node capacitor 101, which is transmitted through each of the sensing signal lines RX1, RX2, . . . , RXn−1, RXn. Here, the sensing signal unit 300 is able to detect the capacitance of each of the node capacitors 101 by calculating the capacitance sensed in a first interval and the capacitance sensed in a second interval.

In the embodiment, the touch panel input device 100 may further include a controller 400. The controller 400 controls the driving signal supplier 200 and the sensing signal unit 300 so that the driving signal supplier 200 outputs the driving signal, and the sensing signal unit 300 senses the capacitance of the node capacitor 101 through the plurality of the sensing signal lines RX1, RX2, . . . , RXn−1, RXn.

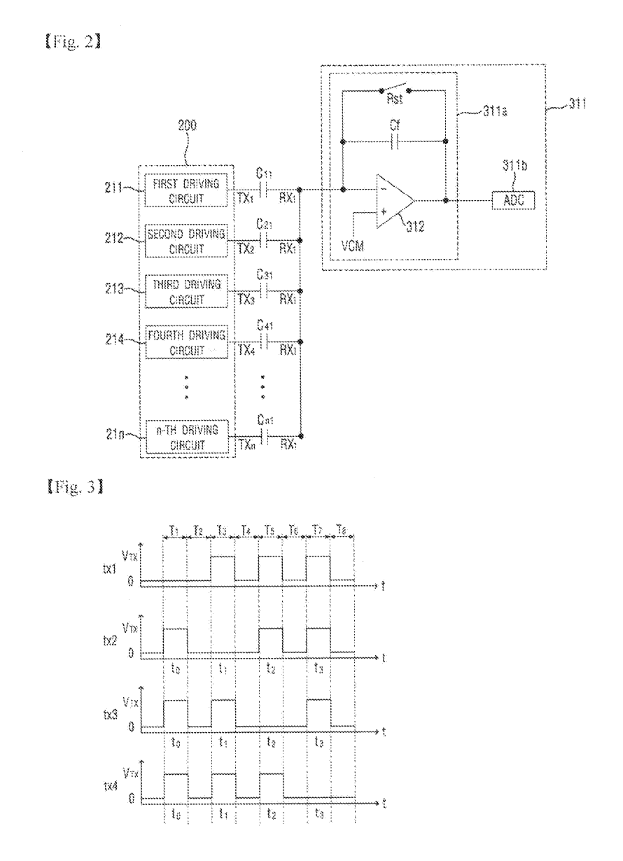

FIG. 2 is a circuit diagram showing a connection relationship between the driving signal supplier, the sensing signal unit, and a sensing capacitor shown in FIG. 1.

Referring to FIG. 2, the driving signal supplier 200 may include a plurality of driving circuits 211, 212, 213, 214 . . . 21n. The driving circuits 211, 212, 213, 214, . . . , 21n may transmit the driving signal by being connected to the driving signal lines TX1, TX2, . . . , Xn−1, TXn. The sensing signal unit 300 may include a plurality of sensing circuits and detect the capacitances of the node capacitors C11, C21, C31, C41, . . . Cn1 in accordance with the sensing circuit. Also, the sensing signal unit 300 is connected to the controller 400 and transmits the signal corresponding to the capacitance of the node capacitors C11, C21, C31, C41, . . . , Cn1 to the controller 400, thereby enabling the controller 400 to identify information on the location of the touch. Here, since it is described that the capacitances of the node capacitors C11, C21, C31, C41, . . . , Cn1, which are transmitted through a first sensing signal line RX1, are detected, only a first sensing circuit 311 among the plurality of the sensing circuits is shown. However, there is no limit to this.

One end of a first node capacitor C1 is connected to a first driving circuit 211 through a first driving signal line TX1, and the other end of the first node capacitor C11 is connected to the first sensing circuit 311 through the first sensing signal line RX1. One end of a second node capacitor C21 is connected to a second driving circuit 212 through a second driving signal line TX2, and the other end of the second node capacitor C21 is connected to the first sensing circuit 311 through the first sensing signal line RX1. One end of a third node capacitor C31 is connected to a third driving circuit 213 through a third driving signal line TX3, and the other end of the third node capacitor C31 is connected to the first sensing circuit 311 through the first sensing signal line RX1. One end of a fourth node capacitor C41 is connected to a fourth driving circuit 214 through a fourth driving signal line TX4, and the other end of the fourth node capacitor C41 is connected to the first sensing circuit 311 through the first sensing signal line RX1. In this way, one end of an n-th node capacitor Cn1 is connected to an n-th driving circuit 21n through an n-th driving signal line TXn, and the other end of the n-th node capacitor Cn1 is connected to the first sensing circuit 311 through the first sensing signal line RX1.

Also, the first sensing circuit 311 sums up the capacitances of the node capacitors C11, C21, C31, C41, . . . , Cn1, which are generated by the plurality of the driving signal lines TX1, TX2, . . . , TXn−1, TXn and the first sensing signal line RX1, through the first sensing signal line RX1, converts the summed result into a digital signal, and then transmit to the controller 400.

The controller 400 may detect the capacitances of the node capacitors C11, C21, C31, C41, . . . , Cn1, which are generated by the plurality of the driving signal lines TX1, TX2, . . . , TXn−1, TXn and the first sensing signal line RX1, by using the summed result converted into the digital signal, and may generate information on the location of the touch. The first sensing circuit 311 may further include an integrator 311a for summing up the capacitances of the node capacitors C11, C21, C31, C41 . . . , Cn1 and may further include an analog-digital converter 311b for converting the result summed up by the integrator 311a into the digital signal. The integrator 311a may include an amplifier 312, an integrating capacitor Cf and a reset switch Rst. The integrating capacitor Cf is disposed between the output terminal and the negative input terminal of the amplifier 312. The reset switch Rst is connected in parallel with the integrating capacitor Cf. The negative input terminal of the amplifier 312 is connected to the first sensing signal line RX1 and receives a signal of the capacitance transmitted from the node capacitors C11, C21, C31, C41, . . . , Cn1.

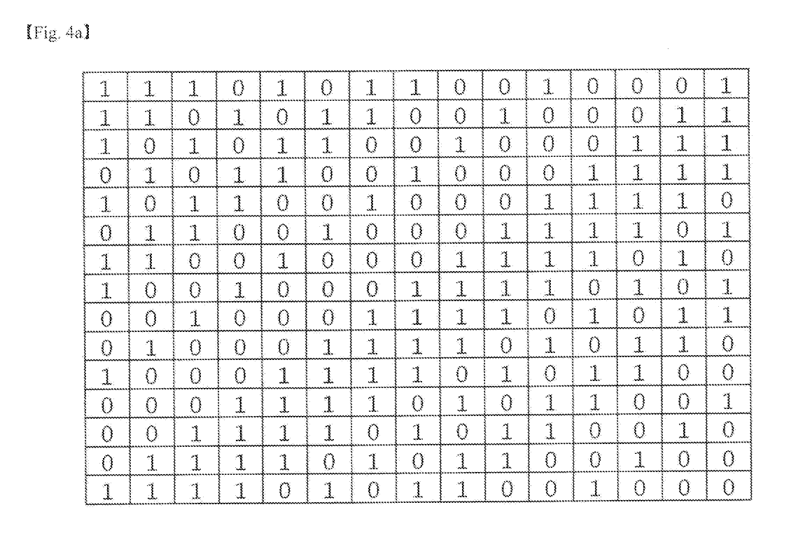

FIG. 3 is a timing diagram showing the first embodiment of the driving signal which is output from the driving signal supplier shown in FIGS. 1 and 2. Here, it is shown that the driving signal to be applied corresponds to a first to a fourth driving signal tx1 to tx4. However, this is intended for the convenience of description. Therefore, the number of the driving signals, the amplitude, etc., of the driving signals may be differently set depending on the size of the touch panel, a driving voltage, and the like. Also, although it is shown that the driving signal is generated in the form of a square wave, there is no limit to this. Also, it is shown that the driving signal is driven to the driving signal line by the driving signal supplier 200, so that a pulse in the high-state is applied to the driving signal line. However, there is no limit to this, and a pulse in the low-state can be generated according to the design of the circuit of the driving signal supplier 200. Also, although it is shown that one pulse is generated in one interval, there is no limit to this, and a plurality of the pulses may also be generated in one interval.

Referring to FIG. 3, the first to fourth driving signal lines tx1 to tx4 alternately become the high-state and the low-state. Particularly, the first driving signal tx1 is in the low-state in the first interval T1, the second interval T2, the fourth interval T4, the sixth interval T6, and the eighth interval T8, and is in the high-state in the third interval T3, the fifth interval T5, and the seventh interval T7. The second driving signal tx2 is in the low-state in the second interval T2, the third interval T3, the fourth interval T4, the sixth interval T6 and the eighth interval T8, and is in the high-state in the first interval T1, the fifth interval T5, and the seventh interval T7. The third driving signal tx3 is in the low-state in the second interval T2, the fourth interval T4, the fifth interval T5, the sixth interval T6, and the eighth interval T8 and is in the high-state in the first interval T1, the third interval T3, and the seventh interval T7. The fourth driving signal tx4 is in the low-state in the second interval T2, the fourth interval T4, the sixth interval T6, the seventh interval T7, and the eighth interval T8, and is in the high-state in the first interval T1, the third interval T3, and the fifth interval T5.

A method for obtaining the capacitances of the first node capacitor C11 to the fourth node capacitor C41 will be described with reference to FIGS. 2 and 3.

First, in the first interval T1, the first driving signal tx1 becomes the low-state and the second to fourth driving signals tx2 to tx4 become the high-state. Therefore, the second to fourth driving signals tx2 to tx4 are driven in the first interval T1, and the first driving signal tx1 is not driven in the first interval T1. When the second to fourth driving signals tx2 to tx4 are driven and transmitted to one ends of the second to fourth node capacitors C21 to C41, the capacitances of the second to fourth node capacitors C21 to C41 correspond to the second to fourth driving signals tx2 to tx4, respectively. However, the capacitance of the first node capacitor C11 can be “0” because the first driving signal tx1 is not driven. A signal corresponding to the result obtained by summing up the capacitances of the second to fourth node capacitors C21 to C41 is transmitted to the negative input terminal of the integrator 311a, so that a voltage corresponding to the result obtained by summing up the capacitances of the second to fourth node capacitors C21 to C41 is charged in the integrating capacitor Cf of the integrator 311a. Accordingly, the voltage corresponding to the capacitances of the second to fourth node capacitors C21 to C41 is output in the first interval T1.

Further, in the second interval T2, the first to fourth driving signals tx1 to tx4 become the low-state. That is, the first to fourth driving signals tx1 to tx4 are not driven. Here, the reset switch Rst connected in parallel with the integrating capacitor Cf of the integrator 311a becomes an on-state, and thus, the integrating capacitor Cf is reset.

Further, in the third interval T3, the first driving signal tx1, the third driving signal tx3, and the fourth driving signal tx4 become the high-state and the second driving signal tx2 becomes the low-state. That is, the first driving signal tx1, the third driving signal tx3, and the fourth driving signal tx4 are driven, and the second driving signal tx2 is not driven. When the first driving signal tx1, the third driving signal tx3, and the fourth driving signal tx4 are driven and transmitted to the one ends of the first node capacitor C11, the third node capacitor C31, and the fourth node capacitor C41, the capacitances of the first node capacitor C11, the third node capacitor C31, and the fourth node capacitor C41 correspond to the first driving signal tx1, the third driving signal tx3, and the fourth driving signal tx4, respectively. However, the capacitance of the second node capacitor C21 can be “0” because the second driving signal tx2 is not driven. A voltage corresponding to the result obtained by summing up the capacitances of the first node capacitor C11, the third node capacitor C31, and the fourth node capacitor C41 is transmitted to the negative input terminal of the integrator 311a, so that the voltage corresponding to the result obtained by summing up the capacitances of the first node capacitor C11, the third node capacitor C31, and the fourth node capacitor C41 is charged in the integrating capacitor Cf of the integrator 311a.

Further, in the fourth interval T4, the first to fourth driving signals tx1 to tx4 become the low-state. Here, the reset switch Rst connected in parallel with the integrating capacitor Cf of the integrator 311a becomes an on-state, and thus, the integrating capacitor Cf is reset.

Further, in the fifth interval T5, the first driving signal tx1, the second driving signal tx2, and the fourth driving signal tx4 become the high-state and the third driving signal tx3 becomes the low-state. Therefore, in the fifth driving signal tx5, the first driving signal tx1, the second driving signal tx2, and the fourth driving signal tx4 are driven, and the third driving signal tx3 is not driven. When the first driving signal tx1, the second driving signal tx2, and the fourth driving signal tx4 are driven and transmitted to the one ends of the first node capacitor C11, the second node capacitor C21, and the fourth node capacitor C41, the capacitances of the first node capacitor C11, the second node capacitor C21, and the fourth node capacitor C41 correspond to the first driving signal tx1, the second driving signal tx2, and the fourth driving signal tx4, respectively. However, the capacitance of the third node capacitor C31 can be “0” because the third driving signal tx3 is not driven. A voltage corresponding to the result obtained by summing up the capacitances of the first node capacitor C11, the second node capacitor C21, and the fourth node capacitor C41 is transmitted to the negative input terminal of the integrator 311a, so that the voltage corresponding to the result obtained by summing up the capacitances of the first node capacitor C11, the second node capacitor C21, and the fourth node capacitor C41 is charged in the integrating capacitor Cf of the integrator 311a.

Further, in the sixth interval T6, the first to fourth driving signals tx1 to tx4 become the low-state. Here, the reset switch Rst connected in parallel with the integrating capacitor Cf of the integrator 311a becomes an on-state, and thus, the integrating capacitor Cf is reset.

Further, in the seventh interval T7, the first driving signal tx1, the second driving signal tx2, and the third driving signal tx3 become the high-state and the fourth driving signal tx4 becomes the low-state. That is, the first driving signal tx1, the second driving signal tx2, and the third driving signal tx3 are driven, and the fourth driving signal tx4 is not driven. When the first driving signal tx1, the second driving signal tx2, and the third driving signal tx3 are driven and transmitted to the one ends of the first node capacitor C11, the second node capacitor C21, and the third node capacitor C31, the capacitances of the first node capacitor C11, the second node capacitor C21, and the third node capacitor C31 correspond to the first driving signal tx1, the second driving signal tx2, and the third driving signal tx3, respectively. However, the capacitance of the fourth node capacitor C41 can be “0” because the fourth driving signal tx4 is not driven. A voltage corresponding to the result obtained by summing up the capacitances of the first node capacitor C11, the second node capacitor C21, and the third node capacitor C31 is transmitted to the negative input terminal of the integrator 311a, so that the voltage corresponding to the result obtained by summing up the capacitances of the first node capacitor C11, the second node capacitor C21, and the third node capacitor C31 is charged in the integrating capacitor Cf of the integrator 311a.

Further, in the eighth interval T8, the first to fourth driving signals tx1 to tx4 become the low-state. Here, the reset switch Rst connected in parallel with the integrating capacitor Cf of the integrator 311a becomes an on-state, and thus, the integrating capacitor Cf is reset.

The voltage which is output from the integrator 311a during the process from the first interval T1 to the eighth interval T8 is output through the analog-digital converter 311b. The voltage can be represented by the following equation (1).

$$[ \begin{matrix}VRX 1 ( T 1 ) \\ VRX 1 ( T 3 ) \\ VRX 1 ( T 5 ) \\ VRX 1 ( T 7 )\end{matrix} ] = ( \begin{matrix}0 & 1 & 1 & 1 \\ 1 & 0 & 1 & 1 \\ 1 & 1 & 0 & 1 \\ 1 & 1 & 1 & 0\end{matrix} ) ( \begin{matrix}C 11 \\ C 21 \\ C 31 \\ C 41\end{matrix} ) \qquad equation ( 1 )$$

Here, VRX1(T1) represents the voltage of the sensing signal in the first interval T1. VRX1(T3) represents the voltage of the sensing signal in the third interval T3. VRX1(T5) represents the voltage of the sensing signal in the fifth interval T5. VRX1(T7) represents the voltage of the sensing signal in the seventh interval T7. C11 represents the capacitance of the first node capacitor C11, C21 represents the capacitance of the second node capacitor C21, C31 represents the capacitance of the third node capacitor C31, C41 represents the capacitance of the fourth node capacitor C41.

$$[ \begin{matrix}C 11 \\ C 21 \\ C 31 \\ C 41\end{matrix} ] = \frac{1}{2} ( \begin{matrix}- 2 & 1 & 1 & 1 \\ 1 & - 2 & 1 & 1 \\ 1 & 1 & - 2 & 1 \\ 1 & 1 & 1 & - 2\end{matrix} ) ( \begin{matrix}VRX 1 ( T 1 ) \\ VRX 1 ( T 3 ) \\ VRX 1 ( T 5 ) \\ VRX 1 ( T 7 )\end{matrix} ) \qquad equation ( 2 )$$

Equation (2) can be obtained by using the inverse matrix of the equation (1). By using this, the capacitance of each of the node capacitors can be found.

In such a manner described above, the capacitances of the first to fourth node capacitors C11 to C41 are obtained. Then, the capacitances of the four node capacitors can be simultaneously obtained, so that it is possible to more quickly detect the location of the touch.

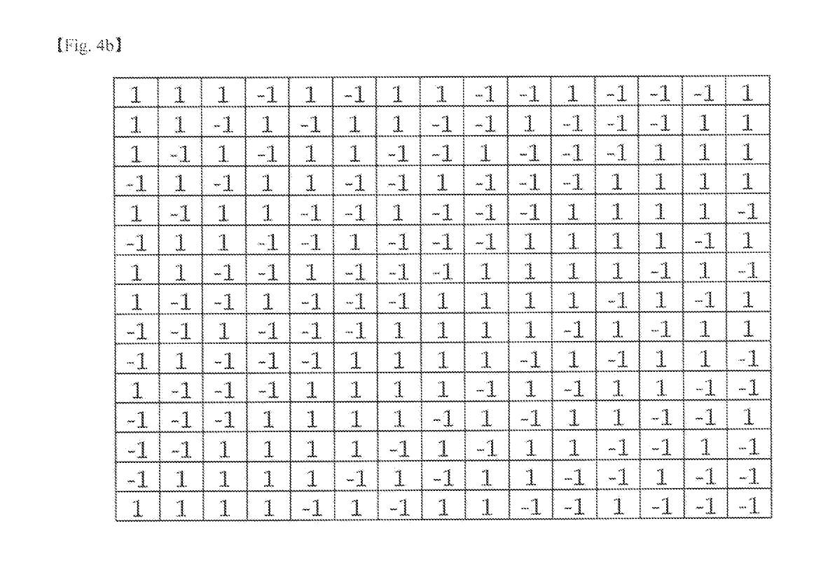

FIG. 4a is a view showing a matrix corresponding to the second embodiment of a waveform of the driving signal which is output from the driving signal supplier shown in FIGS. 1 and 2. FIG. 4b is a view showing an inverse matrix of the matrix shown in FIG. 4a.

The matrix is formed by using a 4-bit pseudo-random bit stream (PRBS) code and has a size of 15×15. However, there is no limit to this. By using a 5-bit PRBS code, a matrix having a size of 31×31 can be obtained. Also, by using a 3-bit PRBS code, a matrix having a size of 7×7 can be obtained. A combination of the driving signals which are simultaneously applied through seven driving signal lines may be formed by using a 7×7 matrix. A combination of the driving signals which are simultaneously applied through fifteen driving signal lines may be formed by using a 15×15 matrix. A combination of the driving signals which are simultaneously applied through thirty one driving signal lines may be formed by using a 31×31 matrix. Here, for convenience of description, the matrix having a size of 15×15 will be described.

Referring to FIGS. 4a and 4b, the 15×15 matrix can be formed by using the 4-bit PRBS code and is shown in FIG. 4b. Regarding the 15×15 matrix shown in FIG. 4b, through the substitution of −1 by 0, the 15×15 matrix shown in FIG. 4a can be obtained. The matrix shown in FIG. 4a is the inverse matrix of the matrix shown in FIG. 4b. The matrices of FIGS. 4a and 4b can be represented by the following equation (3).

$${M}^{- 1} = \frac{1}{8} M \qquad equation ( 3 )$$

Here, M represents the matrix shown in FIG. 4b. M⁻¹ represents the matrix shown in FIG. 4a, i.e., the inverse matrix of M.

By inputting fifteen driving signals to the matrix shown in FIG. 4a through the fifteen driving signal lines in correspondence with the matrix shown in FIG. 4a (“1” means a driving signal, and “0” means a non-driving signal or there is no driving signal), a sensing signal shown in the following equation (4) can be obtained.

$$[ \begin{matrix}VRX 1 ( T 1 ) \\ VRX 1 ( T 2 ) \\ VRX 1 ( T 3 ) \\ VRX 1 ( T 4 ) \\ VRX 1 ( T 5 ) \\ VRX 1 ( T 6 ) \\ \begin{matrix}VRX 1 ( T 7 ) \\ VRX 1 ( T 8 ) \\ VRX 1 ( T 9 )\end{matrix} \\ \begin{matrix}VRX 1 ( T 10 ) \\ VRX 1 ( T 11 ) \\ VRX 1 ( T 12 )\end{matrix} \\ \begin{matrix}VRX 1 ( T 13 ) \\ VRX 1 ( T 14 ) \\ VRX 1 ( T 15 )\end{matrix}\end{matrix} ] = {( M )}^{- 1} ( \begin{matrix}C 11 \\ C 21 \\ C 31 \\ C 41 \\ C 51 \\ C 61 \\ C 71 \\ C 81 \\ C 91 \\ C 101 \\ C 111 \\ C 121 \\ C 131 \\ C 141 \\ C 151\end{matrix} ) \qquad equation ( 4 )$$

In the matrix shown in FIG. 4a, one column of the 15×15 matrix may correspond to one driving signal line, and each row may correspond to the interval in which the driving signal is driven. “0” in each row means that the driving signal is not driven, and “1” means that the driving signal is driven. Therefore, eight driving signal lines to which the driving signal is driven and seven driving signal lines to which the driving signal is not driven are represented in each column of the matrix M. The driving signals driven by the driving signal supplier 200 are applied to the plurality of the driving signal lines in accordance with each of the columns of the matrix M, however, it is intended that the driving signal is driven simultaneously to the at least two of the plurality of the driving signal lines in the first interval, and the driving signal is not driven to at least one driving signal line. Also, it is intended that, in the second interval, the driving signal is not driven to at least one of the driving signal lines to which the driving signal has been simultaneously driven in the first interval among the plurality of the driving signal lines, and the driving signal is driven to at least one of the driving signal lines to which the driving signal has not been driven in the first interval. That is, in FIG. 4a, it is assumed that the first row from the top is the first interval (the first interval T1 in FIG. 3) and the second row from the top is the second interval (the third interval T3 in FIG. 3). First, the first interval shows (1, 1, 1, 0, 1, 0, 0, 0, 1, 0, 0, 0, 1) from the left to the right, and the driving signal is driven to the first to third driving signal lines TX1 to TX3, the fifth driving signal line TX5, the seventh driving signal line TX7, the eighth driving signal line TX8, the eleventh driving signal line TX11, and the fifteenth driving signal line TX15, and the driving signal is not driven to the fourth driving signal line TX4, the sixth driving signal line TX6, the ninth driving signal line TX9, the tenth driving signal line TX10, and the twelfth to fourteenth driving signal line TX12 to TX14. Further, the second interval shows (1, 1, 0, 1, 0, 1, 1, 0, 0, 1, 0, 0, 0, 1, 1) from the left to the right, and the driving signal is driven to the first and second driving signal lines TX and TX2, the fourth driving signal line TX4, the sixth driving signal line TX6, the seventh driving signal line TX7, the tenth driving signal line TX10, the fourteenth driving signal line TX14, and the fifteenth driving signal line TX15, and the driving signal is not driven to the third driving signal line TX3, the fifth driving signal line TX5, the eighth and ninth driving signal line TX8 and TX9, and the eleventh to thirteenth driving signal lines TX11 to TX13. Accordingly, there are driving signals that are not driven in the second interval among the driving signal lines to which the driving signal is driven in the first interval, and there are driving signals that are driven in the second interval among the driving signal lines to which the driving signal is not driven in the first interval.

Through the use of the matrix M shown in FIG. 4b, which is the inverse matrix of the matrix shown in FIG. 4a, the following equation (5) can be obtained. By using the following equation (5), information on the capacitance of each of the node capacitors C11 to C151 can be obtained.

$$[ \begin{matrix}C 11 \\ C 21 \\ C 31 \\ C 41 \\ C 51 \\ C 61 \\ C 71 \\ C 81 \\ C 91 \\ C 101 \\ C 111 \\ C 121 \\ C 131 \\ C 141 \\ C 151\end{matrix} ] = ( M ) ( \begin{matrix}VRX 1 ( T 1 ) \\ VRX 1 ( T 2 ) \\ VRX 1 ( T 3 ) \\ VRX 1 ( T 4 ) \\ VRX 1 ( T 5 ) \\ VRX 1 ( T 6 ) \\ \begin{matrix}VRX 1 ( T 7 ) \\ VRX 1 ( T 8 ) \\ VRX 1 ( T 9 )\end{matrix} \\ \begin{matrix}VRX 1 ( T 10 ) \\ VRX 1 ( T 11 ) \\ VRX 1 ( T 12 )\end{matrix} \\ \begin{matrix}VRX 1 ( T 13 ) \\ VRX 1 ( T 14 ) \\ VRX 1 ( T 15 )\end{matrix}\end{matrix} ) \qquad equation ( 5 )$$

Therefore, the driving signal shown in the matrix formed by using the PRBS code can be simultaneously applied to the fifteen driving signal lines. By using this, the information on the capacitance of the node capacitor can be obtained, thereby more quickly detecting the location of the touch. In particular, when the PRBS code is used, 7×7 matrix and 31×31 matrix are also usable, so that it is possible to control the number of the driving signal lines to which the driving signal is simultaneously applied, and the matrix can be variously applied depending on the size of the touch panel. Here, the matrix which is formed by using 4-bit PRBS code and shown in FIGS. 4a and 4b is nothing but an example, and may have other forms. The matrix formed by using the 4-bit PRBS code satisfies that there are driving signals that are not driven in the second interval among the driving signal lines to which the driving signal is driven in the first interval, and there are driving signals that are driven in the second interval among the driving signal lines to which the driving signal is not driven in the first interval.

Here, although it is disclosed that the combination of the driving signal line to which the driving signal is driven in the same interval and the driving signal line to which the driving signal is not driven in the same interval is formed by the PRBS code, there is no limit to this.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A touch panel input device comprising:
a touch panel including a plurality of driving signal lines and a plurality of sensing signal lines which form a plurality of node capacitors by crossing the plurality of the driving signal lines;
a driving signal supplier which applies driving signals to the plurality of the driving signal lines; and
a sensing signal unit which senses capacitances of the plurality of the node capacitors through the plurality of the sensing signal lines.
wherein the driving signal supplier includes a plurality of intervals in each of which the driving signal is simultaneously driven to at least two of the plurality of the driving signal lines among the plurality of the driving signal lines and the driving signal is not driven to at least one driving signal line among the plurality of the driving signal lines, and wherein a combination of the driving signal line to which the driving signal is driven in one of the plurality of the intervals and the driving signal line to which the driving signal is not driven in the one interval is different from a combination of the driving signal line to which the driving signal is driven in an interval different from the one interval and the driving signal line to which the driving signal is not driven in the different interval.

2. The touch panel input device of claim 1, wherein the driving signals in a certain time interval are represented by a matrix which is formed by a combination of time intervals during which the driving signals are driven and time intervals during which the driving signals are not driven according to a pseudo-random bit stream (PRBS) code.

3. The touch panel input device of claim 1, wherein the sensing signal unit further comprises an integrator, and wherein the integrator sums up the capacitances of the plurality of the node capacitors to which the driven driving signal is transmitted.

4. The touch panel input device of claim 3, wherein the integrator sums up the capacitances of the node capacitors and outputs the summed result, and then resets the result.

5. The touch panel input device of claim 3, wherein the sensing signal unit further comprises an analog-digital converter which is connected to the integrator and converts the signal transmitted from the integrator into a digital signal.

6. The touch panel input device of claim 1, further comprising a controller, wherein the controller controls an output of the driving signal supplier and the sensing of the sensing signal unit.

7. A touch input detection method for sensing a location of the touch by detecting a capacitance of a node capacitor in a touch panel in which the node capacitor has been formed by crossing a driving signal line and a sensing signal line, the method comprising:
allowing driving signals to be applied to a plurality of the driving signal lines such that the driving signal is driven simultaneously to at least two of the plurality of the driving signal lines among the plurality of the driving signal lines in a first interval, and the driving signal is not driven to at least one driving signal line among the plurality of the driving signal lines;
allowing the driving signal not to be driven in the second interval to at least one of the driving signal lines to which the driving signal has been simultaneously driven in the first interval among the plurality of the driving signal lines, and allowing the driving signal to be driven to at least one of the driving signal lines to which the driving signal has not been driven in the first interval; and
calculating the capacitance of each of the node capacitors by comparing the summed capacitances of the node capacitors in the first interval with the summed capacitances of the node capacitors in the second interval.

8. The touch input detection method of claim 7, wherein, in the plurality of the driving signal lines, the driving signal line to which the driving signal is driven and the driving signal line to which the driving signal is not driven are in correspondence with a matrix formed by a pseudo-random bit stream (PRBS) code.
